(19) United States
(12) Patent Application Publication
(10) Pub. No.: US 2007/0278288 A1
(43) Pub. Date: Dec. 6, 2007

(54) CUSTOMER LOYALTY METHODS AND SYSTEMS

(76) Inventor: Mark Simmons, Santa Monica, CA (US)

Correspondence Address: LAW OFFICE OF MICHAEL P. EDDY;MICHAEL P. EDDY, 12526 HIGH BLUFF DRIVE, STE. 300, SAN DIEGO, CA, 92130, US

(21) Appl. No.: 11/306,151

(22) Filed: Dec. 16, 2005

(51) Int. Cl. G06K 5/00

(52) U.S. Cl. 235/380; 705/14

(57) ABSTRACT

An improved system and method for providing a rebate to a third party beneficiary for the purchase of a product from a merchant including the steps of designating a beneficiary for a rebate amount associated with a purchase of goods or services, assigning a rebate amount with one or more restrictions from a merchant based on the purchase of those goods or services by a consumer, and applying one or more rebate amounts to a subsequent purchase by the beneficiary so long as the one or more restrictions are met. Additionally, a computer network-based purchase incentive system for one or more merchants including a memory, the memory adapted to store a program code, a processor in communication with the memory, the program code capable of programming the processor to perform a method for providing a rebate from a merchant for a purchase of a good or service by a consumer, the method comprising the steps of designating a beneficiary of the consumer to receive a rebate amount associated with the purchase, assigning a value and one or more restrictions to the rebate amount; and applying the rebate to a subsequent purchase by the beneficiary so long as the one or more restrictions are met.

### CROSS-REFERENCE TO RELATED APPLICATIONS

None

### BACKGROUND OF THE INVENTION

1. Field

The invention relates to loyalty methods and systems for providing rebates for purchases, in particular, rebates for purchases of products or services that are paid at a later time to third party beneficiaries.

2. Description of the Related Art

Loyalty towards consumer product brands has been a challenge to consumer product providers because consumers are more conscious of price. In general, sellers of consumer products and services such as manufacturers, distributors and retailers have realized that it is much more expensive to attract new customers than it is to retain existing customers. Because of these high acquisition costs, providers have tried to mitigate the reasons a consumer may have to defect to another brand with the use of loyalty systems and methods.

An example of a popular customer loyalty scheme in use is the frequent flyer program. These programs are operated by the airlines as a reward for customers that show loyalty towards those airlines by continuing to fly on those airlines. Airline travelers earn points that can be used towards travel in the future.

Other industries that use customer loyalty programs include the hotel industry, the credit card industry and the rental car industry. The frequent flyer programs, and their equivalent programs in other sectors, have been so successful because the rewards offered have value to the customers.

### SUMMARY OF THE INVENTION

An improved system and method for providing a rebate to a third party beneficiary for the purchase of a product or service from a merchant including the steps of designating a beneficiary for a rebate amount associated with the purchase, assigning a rebate amount with one or more restrictions from a merchant based on the purchase of goods or services made by a consumer, and applying one or more rebate amounts to a subsequent purchase by the beneficiary so long as the restrictions are met. The beneficiary can then use the rebate amount at a future time to purchase other goods or services from the same merchant subject to the one or more restrictions of the rebate amount.

### BRIEF DESCRIPTION OF THE DRAWINGS

The accompanying drawings, which are incorporated in and constitute a part of this specification, illustrate several embodiments of the claimed subject matter, and together with the description, serve to explain the principles of the invention.

FIG. 1 is a flowchart depicting an embodiment establishing a rebate account in accordance with a method of the claimed subject matter;

FIG. 2 is a flowchart depicting an embodiment showing the redemption of a rebate amount in accordance with a method of the claimed subject matter;

FIG. 3 is a flow chart depicting another embodiment showing the establishment and redemption of a rebate account in accordance with a method of the claimed subject matter; and

FIG. 4 is a flow chart depicting another embodiment showing the establishment of a rebate account with an initial purchase, an addition of a rebate amount to the rebate account with a subsequent purchase and the redemption of the rebate account by the beneficiary in accordance with a method of the claimed subject matter.

### DETAILED DESCRIPTION OF THE EMBODIMENTS

Embodiments of loyalty methods and systems that provide rebates to third party beneficiaries for purchases of goods or services are described herein. In the following description, numerous specific details are set forth, such as transactions performed in the context of purchase and rebate activities, to provide a thorough understanding of the various embodiments of the claimed subject matter. One skilled in the relevant art will recognize, however, that these embodiments can be practiced without one or more of the specific details, or with other methods or components.

Reference throughout this specification to “one embodiment” or “an embodiment” means that a particular feature, structure, or characteristic described in connection with the embodiment is included in at least one embodiment of the present claimed subject matter. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Additionally, embodiments of the claimed subject matter may be downloaded as computer program product with instructions transferred from a remote computer such as a server over the internet. They may be used in any client/server environment implemented within multiple network architectures such as the World Wide Web.

With reference to the drawings, several embodiments of the claimed subject matter are schematically depicted by flow charts which are representative of a sequence of events and operations performed by or on behalf of the various users/participants. Each flow chart contains a number of “boxes” identified by reference numbers, which, for ease of discussion, denote an event or operation in one or more of the embodiments.

Overview

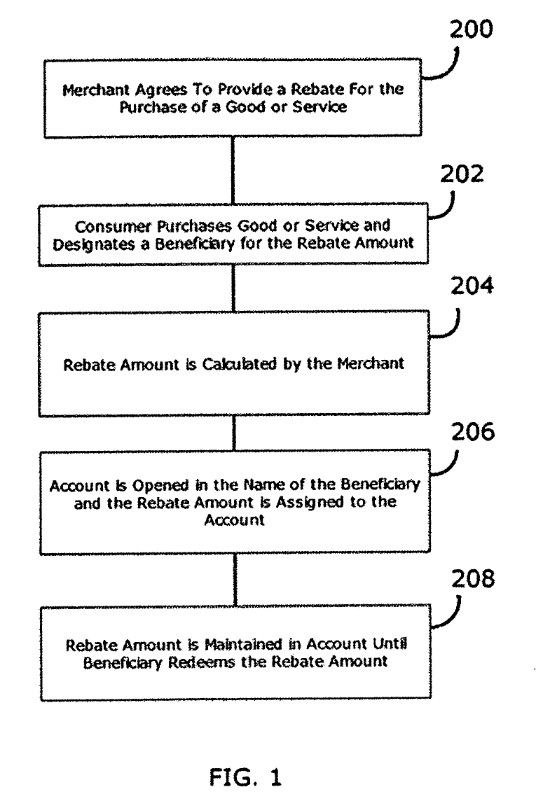

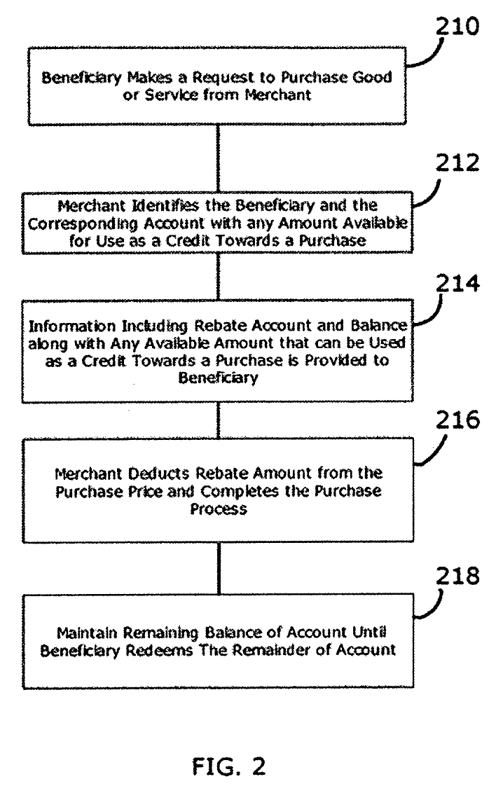

Referring now to the drawings and in particular to FIG. 1 and FIG. 2, an embodiment according to a method and system of the claimed subject matter involves the interrelationship of a merchant, a consumer (or customer) and a third party beneficiary of the consumer. In step 200 of FIG. 1, the merchant offers goods or services or any combination of goods or services with a rebate as an incentive to purchase the goods and/or services. Next, in step 202, the consumer purchases the good or service (or combination of both a good and a service) and designates his or her beneficiary for a rebate amount. In step 204, the rebate amount is calculated by the merchant, typically a percentage of the amount of the sale. If the amount is a flat rate, then this step would not be necessary. A rebate account is next opened in the name of the beneficiary in step 206 and the rebate amount from the purchase is assigned to the newly created account. The rebate account is then maintained in step 208 until the beneficiary elects to use the available amount in the rebate account. In step 210 of FIG. 2, the beneficiary makes a request to purchase a good or a service from the merchant. As shown in step 212, the merchant then identifies the beneficiary and the beneficiary's corresponding account and determines whether or not there is an amount available for use as a credit towards a purchase. Next, in step 214, the information including the rebate account, the rebate account balance and the available amount that can be used towards a purchase based on the restrictions associates with the one or more rebate amounts is conveyed to the beneficiary. At this point, the beneficiary may be offered a chance to review the information or the purchase transaction may proceed with the rebate amount being applied to the purchase price in step 216. The remaining balance of the rebate account, if a positive balance remains, is maintained by the merchant and remains for the benefit of the third party beneficiary subject to the one or more restrictions of the rebate offer or offers that were associated with the purchase or purchases.

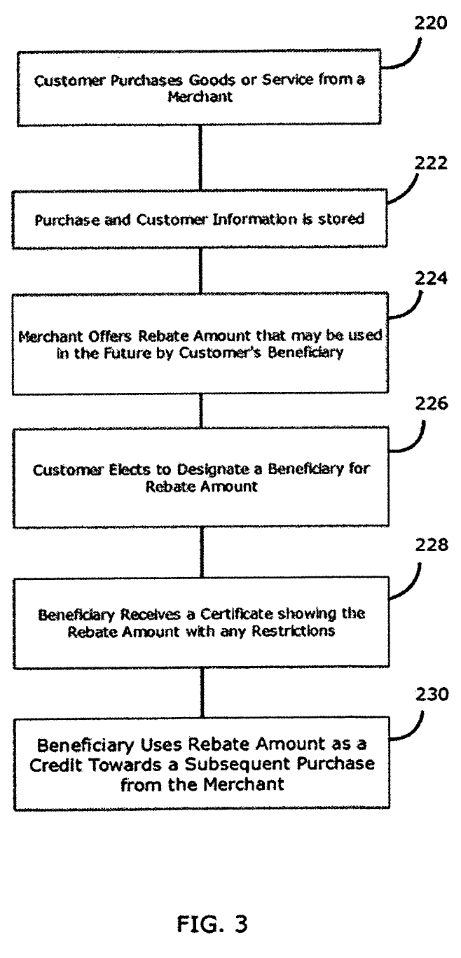

As illustrated in FIG. 3, the process of another embodiment begins at block 220 when a consumer purchases a good or service from a merchant. Next, in block 222, the purchase information along with the customer information is stored for later use.

Subsequent to the storing of the customer and purchase information, block 224 illustrates the merchant following up with the purchaser and offering a rebate amount that may be used in the future by the purchaser's beneficiary. Block 226 depicts the election to receive the incentive offer by the designation of the beneficiary of the rebate amount.

Next, the process passes to block 228 showing that the beneficiary receives a certificate detailing the rebate amount with any restrictions. Block 230 illustrates when the beneficiary decides to use the rebate amount towards a subsequent purchase of goods or services from that merchant.

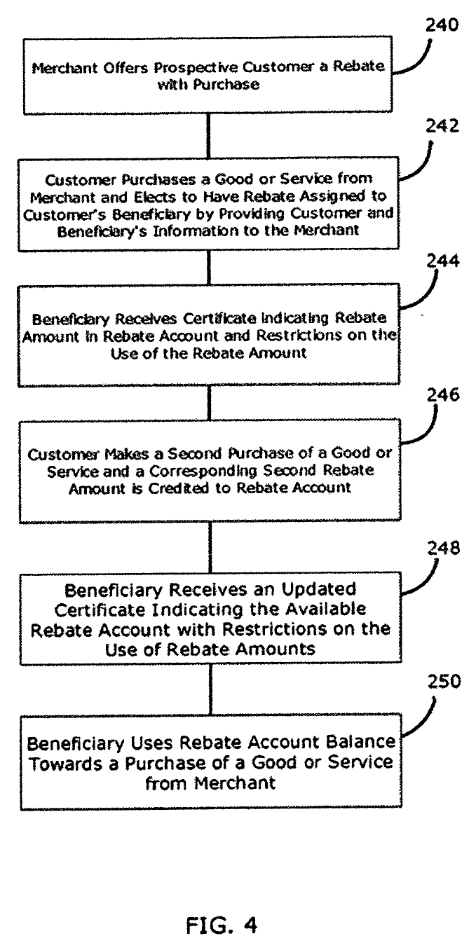

FIG. 4 illustrates another embodiment showing the establishment of a rebate account with an initial purchase, an addition of a rebate amount to the rebate account with a subsequent purchase and the redemption of the rebate account by the beneficiary in accordance with a method of the claimed subject matter. Block 240 depicts the merchant offering a product or service with an associated rebate amount. Next, block 242 depicts the purchase by the consumer along with the election to participate in the rebate offer by the consumer's act of designating the beneficiary for the associated rebate amount, and block 244 illustrates providing the beneficiary with a certificate detailing the rebate amount with any associated restrictions. Block 236 then illustrates a subsequent purchase by the purchaser at the merchant which adds an additional rebate amount to the beneficiary's rebate account. Subsequent to this second purchase, block 238 illustrates the beneficiary receiving an updated certificate showing the updated balance of the rebate account with the associated rebate amount restrictions. Lastly, block 240 illustrates when the beneficiary decides to use the rebate amount towards a subsequent purchase of goods or services from that merchant.

Rebate Account

As used in the following specification and drawings, a “rebate account” can be a fund, an account, a trust account, a trust fund, or any other type of financial or financial equivalent account that may or may not earn interest. Additionally, the amount available in the rebate account may or may not earn interest. The rebate may also be provided in points that can be converted back to a monetary value.

Optionally, the beneficiary can earn additional rebate amounts that are added to his or her associated rebate account when the consumer uses additional services or buys additional goods from the merchant. As further purchases are made by the consumer, the rebates from those purchases are automatically credited to the rebate account.

Rebate Amount

The amount of each rebate 108 may be determined before the sale by the merchant 104 and given to a member or prospect as an incentive or it may be provided to the prospect or member as a percentage of the sale of the good or service or combination or it can be a flat amount. The rebate 108 can be an entry in an accounting ledger or it can be an amount transferred into a fund, such as a trust fund. The amount of the rebate 108, once credited to the beneficiary can optionally earn interest.

In one example, after the purchase transaction is complete, the administrator forwards payment to the merchant.

Restrictions

In many embodiments, it is desirable to condition the availability of the rebates that are received from the merchants on one or more terms that the consumer agrees to at the time of purchase or at the time the consumer elects to become a member of a rebate plan. For example, a member may be required to maintain a minimum amount of purchases on a yearly basis, or a minimum number of purchases per year. Alternatively, the member may be required to make a minimum number or a minimum monetary amount of purchases of related services over a certain time period from the merchant. For example, the consumer may purchase a car and receive a rebate and then be required to use the merchant for several oil changes over the next three years or an periodic intervals when the car has been driven for a specified amounts of miles.

After a period of time from the date the rebate was provided by the merchant, the beneficiary may use the rebate towards a purchase at the same merchant so as long as all the required terms and conditions of the member's agreement are met.

With multiple rebates, some funds may become available for use by the beneficiary earlier than other funds. Additionally, other embodiments may allow a beneficiary to apply the funds to a purchase or multiple purchases to a group of merchants, for instance a group of merchants within a network or at one of a group of dealers that sell products or services for a manufacturer dealer.

In a membership embodiment wherein consumers opt in or elect to become part of a membership program, a feature can provide for a means to “de-list” a member that does not meet the terms of the membership agreement such as a member having financial difficulty at an early stage. The member may also be given an opportunity to comply with the terms of the plan to prevent de-listing or the member may be offered the opportunity to rehabilitate the account by making a subsequent purchase within a specified period of time.

The right of the beneficiary to receive the rebate amount may not mature for several years, and the rebate amounts and accounts can also be restricted in other ways. In some embodiments, the rebate amount is personal to the beneficiary and may not be assigned to another without the permission of the merchant. For example, a consumer may be required to make one or more successive purchases within a certain time frame such as five years from the initial purchase for the rebate amount to be able to be used by the beneficiary. In another example, consumer may be required to purchase several successive services, such as oil changes, for the rebate amount to be available to beneficiary.

In addition, the terms of each rebate amount may require the consumer to return to the merchant at periodical intervals, such as monthly, and purchase a minimum amount of goods or services in order to maintain the balance of the rebate account. In this scenario, should the consumer fail to comply with the terms of the rebate amounts or the rebate account or both, the balance of the rebate account would be reduced in an amount equal to the delineated penalty or penalties. Should the account balance reach zero, the consumer would be required to being the process again with a new purchase.

There need be no restrictions on the use of the customer rebate, but in most instances, time restrictions may be applied to each rebate account. For example, a merchant may want the beneficiary to return in several months or years. The rebate amount may alternatively only be available during certain periods such as period of time that has been historically slow at the merchant.

Other possible restrictions on the use of the rebate amounts include that the rebate be used towards a maximum percentage discount on another purchase, for instance a maximum of 10% on a new car. The maximum amount of a discount could also be adjusted to each purchase such as a $1000 rebate could only be used on a purchase of an automobile of $15,000 or more. Other straight percentage discounts may be used, such as 20% or 50% and the rebate amounts or rebate account may be restricted to purchases over a certain value, for example over $1000.

A time limit may also be placed on how long the rebate may be used after the rebate amount becomes available. The time period between the initial purchase and the subsequent purchase may be short, even being the same day, or it may be very long, such as several months depending upon the business, the good or service being offered, or the desires of the merchant.

A rebate limit can also be set by a merchant so that the amount of the rebate available in any one purchase cannot exceed a certain amount or the number of rebates available cannot exceed a certain number.

Reverse Bidding by Merchants to Win Consumer's Business

Rebate amounts may also be set by the Beneficiary in a reverse bidding situation so that the Beneficiary can direct the Consumer to purchase from a particular merchant or group of merchants that bids the highest amount in rebate amounts and/or a rebate amount with the least restrictions or any combination of the two. In this way, multiple merchants compete for consumer's business by placing a bid to offer a rebate amount with the highest amount or the least restrictions in order to win the consumer's business.

Redemption of the Rebate Account With the One or More Rebate Amounts

The beneficiary can also redeem a rebate amount when portions of that rebate amount are in more than one rebate accounts. The available rebate amounts in multiple rebate accounts may be combined and used as a discount towards the subsequent beneficiary purchase.

Account Retrieval and Monitoring

In several embodiments, the rebate account may be monitored at any time online by the beneficiary, the consumer, the merchant or an administrator or any other entity such as a data aggregating entity. For example, once authenticated, the beneficiary can retrieve and view his or her account balance and use any available balance as a credit towards a purchase. In the online environment, for example, once authenticated, the beneficiary is able to navigate various web pages corresponding to the merchant along with the rebate account balance and available rebate amount information output from an web server that would include any commercially available accounting server. These information pages would suitably be linked to product purchase pages so that the beneficiary could navigate to a product or service page, apply the rebate to the purchase amount and complete the purchase transaction.

Multiple Consumers May Contribute to a Single Rebate Account

In some embodiments, more than one consumer can contribute to the rebate account with purchases. In the case of a single beneficiary and multiple consumers, multiple rebate amounts are assigned to the single beneficiary.

Multiple Purchases by the Beneficiary

Similarly, the beneficiary of one or more rebate accounts with one or more rebate amounts may use the rebate amounts, when the restrictions are met, to purchase several products or services.

Member Merchants

More than one merchant or affiliates may join together to offer their customer base a similar rebate incentive and each can then solicit and establish new relationships with consumers.

Additional Contributions as Gifts

Other people can contribute to the rebate account or accounts and these contributions may be applied to the subsequent purchase by the beneficiary. These contributors may be friends, relatives, or any third party that wishes to add money by making a gift or contribution to the beneficiary's rebate account thereby increasing the discount available for the purchase of the automobile or other product or service.

Multiple Beneficiaries

There can also be multiple beneficiaries, for example in the case of a parent with several children that wishes to split a rebate 108 between the children's individual rebate accounts 110. In this example, a rebate 108 could be divided amount several rebate accounts 110 or a it could be applied to a single rebate account 110 that could benefit more than one beneficiary 106. In the latter instance, the single rebate account 110 could be split equally amount the beneficiaries 106 or it could be applied in any suitable percentages.

Membership Plans

Embodiments of the methods and systems according to the claimed subject matter may also be implemented in a membership plan so that members elect to be included in the incentive program upon joining the membership. Similarly, embodiments could be implemented into existing membership plans so that members of existing plans are opted into an embodiment of the rebate method or system.

Methods of Calculating an Incentive Rebate:

Various methods of calculating a rebate amount may be used including a percentage of the gross sale, the net sale or a flat amount set by the merchant or manufacturer or a third party intermediary.

Methods of Purchases

Once a consumer or beneficiary has located a product or service of interest, the actual sales process is initiated at the merchant's physical or internet storefront.

In an example wherein the transaction takes place over the internet, i.e. where the buyer (either a consumer or a beneficiary in this embodiment) locates something to buy at the web site of a merchant, distributor, or manufacturer. Once the product or service is located on a web site, the buyer may initiate the purchase by clicking a link, for example the buy or add to cart button or an inquiry button, to indicate his or her intention to proceed with a purchase a given product or service. The rebate account information would then be entered as a code to activate the application of the rebate amount as a discount to the purchase price. The buyer then could complete the purchase conventionally using a credit card or other payment method accepted on the merchant's website.

In addition to Internet-based sales, transactions among members of the network can take place in a manner similar to conventional point-of-purchase sales or direct contact methods. Alternatively, the consumer and beneficiary may contact the merchant or seller directly via phone, facsimile, e-mail or any other suitable means to convey its intention to purchase a product or service.

### Automobile Embodiment

A first embodiment is directed toward the purchasers of automobiles. Many purchasers of cars and car owners frequently contribute towards their child's first car in their desire to provide financial and emotional support to their child. This embodiment provides an incentive or loyalty scheme that rewards a parent by assisting his or her child with the purchase a new car. This present embodiment provides a reward without impacting the current, pending, near term sale, or past sale of a car by avoiding the subsidization of the purchase.

In this example, the consumer that normally replaces his or her car with a new one of the same brand at regular intervals would receive a rebate amount for each purchase credited to the consumer's designated beneficiary. Additionally, other loyalty rewards may be credited to the rebate account. For instance, every year that the consumer owns a car of the required brand and meets all terms and restrictions of one or more previous rebate offers, the beneficiary would receive an amount credited to their rebate account. In this example, an automobile manufacturer places a rebate amount of $500 and/or any additional incentive amount into an interest-bearing account for the nominated beneficiary whom is a child or a grandchild. When the funds in the rebate account become available, they, in addition to any other rebate amounts, can be used as a credit against the purchase of a new car. Here, the beneficiary child or grandchild would then be able to purchase a more expensive car than they would have otherwise been able to afford without the available rebate amount.

In this example, an incentive membership plan may also be used where a customer elects to become a part of the rebate program or plan according to this embodiment. In this case, a member would show his or her loyalty to the brand with further purchases that will provide a future benefit to the beneficiary. Any number of repeat purchases may be made over an extended period of time, for example over ten to twenty years, for rebate offer amounts to be credited to the beneficiary's rebate account.

Further, one or more follow up purchases may also be required under the terms of the rebate plan itself, or under the terms of each rebate amount or both of the aforementioned. Other embodiments may have different restrictions, terms or conditions or no other restrictions may be required for various premium levels of member customers for a beneficiary to be able to receive the rebate amounts in the rebate account.

In a specific example, a member of the incentive plan may be a father who makes purchases of a automobile brand over a period of time with each purchase contributing to his son's account, with his son designated as the beneficiary. The son in this example could redeem the rebate account after a predetermined number of years and use the amount as a credit towards the purchase of a new automobile of the same brand. The member's purchases accumulate good will for the brand and they help the father buy his son a new car at an appropriate time.

In some circumstances, multiple rebate offer amounts may be redeemed by the beneficiary so that multiple rebate amounts can be applied to more than one purchase. For example, an amount less than the full amount available in the rebate account may be applied as a discount for one or more purchases by the beneficiary at one or more participating merchants. In each of these alternate examples, the consumer views the merchandise in the auto dealership, and the sales staff has an opportunity to present information to the consumer and solicit a purchase. During this visit, the rebate can be offered as an incentive to make the purchase, and the rebate can be used by a third party beneficiary as a subsequent credit towards an automobile purchase.

The consumer may also nominate more than one beneficiary such as two or more children for the same rebate amount, which can then be shared among the children either proportionally or non proportionally according to the wishes of the consumer. The fractional rebate amounts could then be used by each of the children when the restrictions of the rebate amount are met and individually at times when each decides to purchase a car from the merchant or manufacturer.

Another alternative or additional restriction in this embodiment would require the consumer to use only certain automotive suppliers for after sales products and/or services such as oil changes and the like. The present example could also be combined or implemented with membership plans or other incentive offers offered by other entities.

In many of the above automobile embodiments, once a purchase is completed by the consumer, the rebate account is established and the rebate amount resulting from the purchase is assigned or credited to the newly established account. After the initial purchase and designation, the beneficiary may receive regular statements periodically. The statements are provided either from the merchant automobile dealership or from the automobile manufacturer.

In an online embodiment, the beneficiary can login to a website on the internet provided by the merchant or manufacturer to view the rebate account balance or an individual rebate amount and its associated restrictions. This interaction reinforces the affinity of the brand by allowing the beneficiary to be reminded of the availability of the future rebate account. On each anniversary of the inception of the rebate account, the consumer and the beneficiary both may also be sent a rebate account statement indicating its present available value and total amount. Because the information collected from the purchaser may include the age of the beneficiary, the merchant and/or manufacturer can avoid the embarrassment of sending age inappropriate sales messages to an under aged beneficiary. In this way, a dealership and/or manufacturer would have an opportunity to initiate a positive contact with the beneficiary and that contact would be at an appropriate time that could gain the attention of the beneficiary through age-appropriate activities.

One possible restriction is that if a nominated beneficiary has not used the money in the fund to help purchase a new car within a set period of time, for example two years after being eligible to drive, the entire rebate account amount would be returned to the merchant or the manufacturer that originally credited the rebate account. Similarly, if the owner opts out of the scheme, by not replacing his car every three years, the accumulated funds will be returned to the entity providing the benefit. In both cases the manufacturer has the opportunity to freeze the funds, which can be used to entice a lapsed owner to repurchase the car brand or nominated child to reconsider buying the car brand.

In some examples, where a consumer has not elected to join the rebate program or plan or does not designate a beneficiary, follow up marketing may be used by the dealership or manufacturer to solicit the purchaser further. For example, if after the current or future car owner is initially invited to sign up when a car is purchased and he or she declines the offer, he or she may be contacted once or more at a later time with an invitation to join and receive the credit for their one or more car purchases.

In the forgoing examples, so long as the car owner abides by his or her obligation to replace his car with a new car from the same manufacturer at least once every three years, the manufacturer agrees to credit $500 for each enrolled year into the beneficiary's rebate account which is further held in a trust account accruing interest at prime rate. If and when the nominated beneficiary chooses to redeem the rebate account funds, the manufacturer makes the amount available to him as a discount against the purchase of a new car.

As previously described, the rebate account may also be supplemented by rebates derived from additional purchases by the consumer or by direct contributions into the account by anyone or any entity. Additionally, after a rebate balance has been established, the beneficiary can request that the cumulative rebate account balance be applied to a purchase of goods or services subject to the terms and conditions of any restrictions on the one or more rebates.

### Grocery Store Embodiment

Another example is an incentive program for a grocery store that wishes to offer its consumers a rebate that can be designated for one or more beneficiaries. In this example, all purchases that are made by the consumer earn rebates for the third party beneficiary. A grocery store could advertise incentives such as this to draw in and retain shoppers over a longer period of time.

Administrator

An administrator can be used to monitor the purchases and rebate amounts of the consumer and maintain the rebate accounts on behalf of the beneficiaries. In these embodiments, the administrator receives purchase data from the retailer, such as customer identity, beneficiary identity, product identity, and rebate amount and its associated restrictions. The administrator would then maintain the rebate account and provide a credit to the retailer at the required time of purchase by the beneficiary, allowing the merchant to avoid dealing with the time and expense of maintaining the rebate account. The administrator may also take a commission as compensation for the work. Additionally, an administrator program may be used to maintain the rebate account information. It may include a server and ancillary equipment capable of storing and processing data generated in the course of operation of a network so that the account information may be easily accessed.

The data that is made available to the merchant, consumer and beneficiary can include the identity and associated information for each beneficiary, the balance of the rebate account and the amount of the rebate currently available to that beneficiary towards a subsequent purchase, a record of all sales to the consumer, and any other relevant information such as the restrictions placed upon each rebate amount and each rebate account. This data can be accessed and updated on a real time basis for use in the rebate account maintenance process or in the rebate transaction process when used with an administrator via the phone, internet, e-mail, fax or other means.

In this way, once an account is opened and a customer rebate is credited to a rebate account, the rebate account may be maintained by the administrator while at the same time be monitored by the merchant, the beneficiary and the consumer.

In an example using a computer network or system to transmit the available rebate account balance, the request to use the balance of the rebate account may be transmitted to an administrator where an initial inquiry is made as to whether the beneficiary has an available rebate amount in the rebate account. If not, the request is declined and the merchant is notified of the declination. If there is an account, the administrator would return the rebate account balance as well as the available rebate amount in the rebate account.

Inquiries

The balance of recorded sales may also be available to the consumer, merchant and beneficiary. The consumer may also elect to make the previous purchase information unavailable to the beneficiary. Any information related to rebate amounts that are on hold or delayed due to the terms of the individual rebate can also be provided. For example, an additional term of a rebate amount would include that the beneficiary must wait a predetermined period of time before he or she can take advantage of the rebate. There can also be a period of delay for the application of a rebate amount to a beneficiary's account, for example from a few days to a few months to allow for the verification of the purchase in instances of large amounts, to allow for a period of time to pass wherein purchases could be returned to the merchant, or to ensure that the purchases made were not fraudulent. If any problems arise during this time period, the amount would be debited from the rebate account and the rebate amount would not be available to the beneficiary.

Assuming that such period passes, the sale is finalized and the rebate amount is credited to the rebate account balance and any restrictions are recorded along with the credited amount. An administrator may also provide this service to one ore more merchants for a service fee or a commission of the rebate amount or account. As some rebates may be restricted by requiring subsequent purchases, rebate accounts may be reviewed or updated on a periodic basis to ensure that purchases are being made periodically by the consumer. In the present example, an audit of each account is conducted yearly to examine the ongoing balances and rebate contribution and deduction activity during the previous year in order to verify compliance with the terms of the rebate amounts. The information derived from the review can also be used to examine the efficacy of each program and to provide suggestions for any adjustments to existing or future incentive offers. Any other period could also be chosen for the review process

Rebate Issuer

For example, the rebate issuer can be the merchant, the manufacturer of the goods being purchased, a sponsor, a shopping mall, a financial institution, or any other entity.

Commissions to Third Parties Possible:

In some embodiments such as membership plans, an additional commission may be provided to the plan entity or the administrator administering the membership plan.

Form of Customer Rebate

The customer rebate may be in the form of a rebate card, a printed check, a money order, a credit to an account used to purchase the product (such a credit card account or bank account), a discount applied to the purchase price of the product, a coupon allowing further purchases up to a certain value, a discount coupon, credit to a PayPal account, PPCC or similar web-based account, travelers check, air miles, cash, check, or other form of financial instrument, credit, or discount.

In other examples, a record of the rebate amount can be provided to the beneficiary in the form of a gift card of predetermined value or a certificate printed at the time and place of purchase with either indicating the restrictions of the use of the rebate amount. It may also be provided as a preprinted coupon or a voucher at the time of sale or any of the above may be mailed to the beneficiary's address. The amount of the rebate amount may also be advertised with the product or it may be offered after the purchase has been made by the consumer.

Rebate Card

In some examples of this invention, the retailer provides a rebate card at the time of purchase which can be used in the future by the beneficiary. Alternatively, if the beneficiary already has a loyalty card from the merchant, the retailer can apply the rebate amount and restriction information to the card. The rebate card may itself carry the rebate amount as data stored on a magnetic strip, chip, or other data storage mechanism on the rebate card, or through it may contain the beneficiary's identifying information such as an account number so that the beneficiary's rebate account can be referenced. The rebate card may also function as a loyalty card.

Rebate Card Provided by Administrator

In other examples, the rebate card, rebate amount or rebate certificate is provided by an administrator of the rebate program system. A merchant would recognize the card, and once validated and an available rebate amount determined, provide a credit to the beneficiary for the purchase. Hence, a group of merchants could join together to offer the rebate program to a wide base of the group's consumers. Customer data provided by the customer to obtain the rebate card can be stored by the administrator and used for incentive program marketing. In one example, the consumer makes a purchase at a first retailer and a beneficiary receives a rebate amount credited to his or her rebate account. Once the terms of the rebate have been met, the beneficiary could use the rebate amount as a credit towards a purchase from any participating merchant.

For example, a customer may obtain cumulative rebates from a number of retailers, or may also receive rebates added to the same card through use of associated credit cards, cell phones, airline ticket purchases, online purchases, or any other purchase through an associated company. The customer can accumulate the rebates and use that cash equivalent to make purchases, either through associated retailers, or through websites, or through any other method.

Smart cards as Rebate Cards

A rebate card can also be in the form of a smart card which can include the identification of the customer and beneficiary, for example a name, an identity number, account number, other code, or other identifier, and be used to track purchasing patterns of the customer, and to track any additional purchases from the retailer with their associated restrictions. It may also add rebate amounts to the rebate account balance and calculate the available rebate amounts based on the restrictions provided by the merchant at the time of sale. Any other restrictions associated with the individual rebate amounts may also be recorded and retrieved on the smart cards.

In use, a rebate card may be swiped at the point of sale through any number of commercially known rebate card reader attached to the point of sale device such as a cash register. An account containing a credit corresponding to the customer rebate may also be stored on a database available to the retailer or the value of the rebate account can be encoded in a data storage mechanism (such as a magnetic strip) on the rebate card.

Loyalty Cards

Many merchants operate a loyalty program with their own loyalty cards that identify the customer and allow a merchant to track every purchase made by the customer. Frequently, these cards also allow the customer to receive a purchase discount and this tracked information can be used to identify a consumer's interests, buying habits, or any other similar information. In embodiments of the present invention, a similar loyalty card may be provided to the consumer as well as the beneficiary to identify the parties as well as maintain the rebate amount information and the purchase history information.

Data Retained for Future Use

The data of the initial and subsequent purchases can be used for statistical analysis and later use in changing rebate programs to better meet the needs of members and their beneficiaries. Rebate and purchase information can also be shared between multiple merchant and automobile manufacturers for similar purposes. Other data collected that may be associated with the consumer and beneficiary include demographic data related to the consumer and beneficiary and any previous purchases by the consumer or beneficiary.

While the invention has been described with referenced to multiple embodiments, it should be understood by those skilled in the art that various changes and modifications may be made and equivalents may be substituted for elements thereof without departing from the scope of the claimed subject matter. Therefore, the claimed subject matter is not limited to the various disclosed embodiments including the best mode contemplated for carrying out the claimed subject matter, but instead includes all possible embodiments falling within the scope of the appended claims.

What is claimed is:

1. A method of providing a rebate from a merchant for a purchase of a good or service by a consumer comprising the steps of:
designating a beneficiary of the consumer to receive said rebate amount associated with said purchase;
assigning a value and one or more restrictions to said rebate amount; and
applying said rebate to a subsequent purchase of goods or services by said beneficiary so long as said restrictions are met.

2. The method of claim 1, wherein said rebate amount is received from one or more of the following group: indirect merchants, distributors, manufacturers, agencies, loyalty programs and a third party holding company.

3. The method of claim 1, wherein said beneficiary is more than one beneficiary.

4. The method of claim 3, wherein said rebate amount is allocated in equal amounts among the two or more beneficiaries.

5. The method of claim 3, wherein said rebate amount is allocated in unequal amounts among the two or more beneficiaries.

6. The method of claim 1, wherein said restrictions must be met by said beneficiary.

7. The method of claim 1, wherein said restrictions must be met by said consumer.

8. The method of claim 1, wherein said restrictions must be met by said beneficiary and said consumer.

9. The method of claim 1, wherein said goods or services are the same type of goods or services as were purchased by said consumer.

10. The method of claim 1, wherein said rebate amount is more than one rebate amount.

11. The method of claim 1, wherein said purchase is more than one purchase.

12. The method of claim 1, wherein said beneficiary can be re-designated.

13. The method of claim 1, wherein said consumer is a member of an incentive program or plan.

14. The method of claim 1, wherein said good is an automobile.

15. The method of claim 1, wherein said good is selected from the following group: a vehicle other than an automobile, a bicycle, a grocery store product, a credit limit, and an article of furniture.

16. The method of claim 1, wherein said rebate amount is held in a rebate account selected from at least one of the following group: a ledger account, a checking account, an annuity, a debt security, an equity security, a certificate of deposit, a savings account, and an insurance product.

17. The method of claim 1, wherein said rebate amount is a percentage of the gross sale.

18. The method of claim 1, wherein said rebate amount is a fixed amount.

19. The method of claim 1, wherein said merchant is more than one merchant.

20. The method of claim 1, wherein said rebate account is an interest bearing account.

21. The method of claim 1, wherein the rebate is provided to the beneficiary customer in the form of one of the following group: a rebate card, a certificate, a voucher, a letter, a merchant loyalty card, and a smart card.

22. The method of claim 1, further comprising the step of using data derived from said rebate account redemption activity to make adjustments to current and future rebate amount offers or restrictions.

23. A computer network-based purchase incentive system for one or more merchants, comprising:
a memory, the memory adapted to store a program code;
a processor in communication with the memory, the program code capable of programming the processor to perform a method for providing a rebate from a merchant for a purchase of a good or service by a consumer, the method comprising the steps of:
designating a beneficiary of the consumer to receive said rebate amount associated with said purchase;
assigning a value and one or more restrictions to said rebate amount; and
applying said rebate to a subsequent purchase by said beneficiary so long as said restrictions are met.

24. A computer program product for use in conjunction with a computer system, the computer program product comprising a computer readable storage medium and a computer program mechanism embedded therein, the computer program mechanism, comprising a program module, the program module including instructions for providing a rebate from a merchant for a purchase of a good or service by a consumer including:
designating a beneficiary for a rebate amount associated with a purchase;
assigning a rebate amount with one or more restrictions from a merchant based on said purchase made by a consumer;
and applying said rebate amount to a subsequent purchase by said beneficiary so long as said restrictions are met.
